(19) United States
(12) Patent Application Publication
(10) Pub. No.: US 2012/0046188 A1
(43) Pub. Date: Feb. 23, 2012

(54) Solid Support for HCV Detection

(75) Inventors: Jean-Luc Berland, Succieu (FR); Glaucia Paranhos-Baccala, Lyon (FR)

(73) Assignee: bioMerieux, SA, Marcy L'Etoile (FR)

(21) Appl. No.: 13/258,125

(22) PCT Filed: Mar. 25, 2010
(86) PCT No.: PCT/FR10/50538

§ 371 Date: Sep. 21, 2011

(30) Foreign Application Priority Data
Mar. 30, 2009 (FR) 0951949

(51) Int. Cl. C40B 30/04; C40B 40/10

(52) U.S. Cl. 506/9; 506/18

(57) ABSTRACT

The present invention relates to a solid support for an immunological test for the detection of HCV, to which the following are attached:
a) at least one antibody directed against the HCV Core protein, and
b) at least one polypeptide consisting of (i) a peptide of the HCV E2 protein, chosen from the E2 protein itself and one or more of its epitopes, and (ii) a peptide of the HCV E1, NS4B and/or NS5A proteins, chosen from the proteins themselves and one or more of their epitopes, and, where appropriate, of (iii) a peptide of the NS3 protein, chosen from the protein itself and one or more of its epitopes;
   or alternatively:
a) at least one antibody directed against the HCV Core protein,
b) a peptide of the HCV E2 protein, chosen from the E2 protein itself and one or more of its epitopes, and
c) a peptide of the HCV E1, NS4B and/or NS5A proteins, chosen from the proteins themselves and one or more of their epitopes, with, where appropriate,
d) a peptide of the NS3 protein, chosen from the protein itself and one or more of its epitopes.

The present invention relates to the field of hepatitis C diagnosis and in particular to a solid support that can be used in a method for simultaneously detecting a hepatitis C virus (HCV) antigen and an antibody directed against an HCV protein.

The first generation of tests for detecting HCV infection was based on the detection of antibodies directed against NS3/NS4 nonstructural proteins (EP 0 318 216; Choo et al (1989)) using, in particular, a protein c100-3 of approximately 360 amino acids fused with the superoxide dismutase protein. However, this first generation made it possible to detect only 70 to 80% of sera infected with the virus.

The second generation of tests, still based on the detection of antibodies, incorporated antigens of several regions, in particular of the Core protein, and of the NS3 and NS4 proteins (Mimms et al (1990); EP 0 450 931). This second generation represented significant progress since the sensitivity exceeded 95% (Alter et al (1992)).

The third generation of tests added to these Core, NS3 and NS4 antigens an additional recombinant protein of the NS5 region (Courouce et al (1994)).

Nevertheless, this detection is envisioned for patients exhibiting symptomatology of chronic liver disease caused by HCV and detects poorly its early phase (patients with a suspicion of acute-phase hepatitis C). For example, this format can allow through the blood material of certain contaminated blood donors in the context of a blood transfusion. The detection of the virus itself is necessary as early as possible after contamination and before the appearance of the antibodies. This is done by detecting the nucleic acids using a PCR (polymerase chain reaction) amplification technique as described by Garson et al. (1990). This technique unfortunately remains complex to carry out from the point of view equally of the sample preparation, of the risks of contamination and of automation. Another approach for the purpose of early detection of HCV infection consists of the detection of the circulating viral antigen of the Core protein as described by Takahashi et al (1992), although the amount of detectable Core antigen is low and the assay remains complex to carry out.

In order to overcome these drawbacks, an assay for detection in combination (called COMBO) of the HCV antigens and of the antibodies directed against HCV represents a good balance in order to benefit from both an early detection, by detection of the antigen, and from the monitoring of the patient's chronicity, by detection of the antibodies.

However, this poses a major problem, namely that of the interference, concerning the assaying of the HCV Core antigen, between the anti-HCV antibodies present in the serum and labeled anti-HCV antibodies used for detecting the antigen.

This is particularly true in a system of simultaneous detection, on the same solid phase, of anti-HCV Core protein antibodies and of HCV Core antigen. Thus, the depositing on the solid phase, with a view to detecting anti-HCV Core protein antibodies, of a Core antigen which has the same epitopes as those recognized by the labeled anti-HCV Core protein antibodies, used with a view to detecting the Core antigen, leads to an attachment of labeled antibodies on the solid phase and results in a to false-positive response of the assay. Similarly, in a process for fabricating a solid support where it is necessary to attach both a Core antigen and an anti-Core protein antibody, it is not possible to coat the solid phase with a solution containing a mixture of these two components, otherwise there will be blocking of the antibody sites by the antigens used for coating the solid support, preventing the subsequent reaction of said antibodies with the antigens of the patient serum. These competition phenomena are therefore very disadvantageous for developing an effective test.

WO 00/07023 proposes a COMBO test with the detection both of the Core antigens and of the anti-Core protein antibodies, in which, in order to avoid the problem of interference, the Core protein epitopes, chosen for the various components of the kit, are different. Since there is not an unlimited number of Core epitopes, this technique has the drawback of using minor epitopes that are poorly recognized.

An approach which is similar, but systematized for combining a maximum number of non-overlapping epitopes of the Core protein and of anti-Core protein monoclonal antibodies, is described in WO 2008/027942, still in order to avoid this problem of interference.

EP 1 251 353 uses the same technique but with a more complete mixture of antigens (NS3, NS4, NS5, Core) for detecting the antibodies, but still with this problem of interference for the Core protein.

WO 03/095968 solves this problem by structurally modifying, in particular by amino acid substitution, certain target epitopes of the antigens used for the antibody capture. The epitopes thus modified are then destroyed. Simultaneously, the antibodies used for capturing and/or detecting the antigens are those chosen such that they in fact recognize unmodified epitopes present on the patient's antigens, and that they thus cannot bind to the modified antigens, which no longer have these same epitopes. Since the epitopes are no longer identical, there is no longer any competition between the antibodies used for capturing and/or detecting the HCV antigen, and the patient's antibodies. The capture of the Core antigen and that of the anti-Core protein antibodies will be able to be carried out on one and the same protein region of the Core protein and will avoid the loss of detection of a certain number of anti-Core protein antibodies. A similar strategy is described in WO 03/002749, where the Core protein is modified so that certain epitopes are not recognized by the monoclonal antibodies used in the assay.

WO 01/096875 describes a COMBO assay in which this interference problem is solved by combining the detection of the HCV Core antigen and of the antibodies directed against the discontinuous epitopes present in the NS3/NS4a 680 amino acid (aa) protein. However, the sensitivity/specificity results are very limited in this application and it is not demonstrated that the level of sensitivity is sufficient for a detection test.

There is therefore a need for a combined antigen and antibody HCV detection test which is sensitive and specific, as simple as possible, and which avoids the problem of interference between the antigens and the antibodies directed against the Core protein.

For this purpose, a solid support for an immunological test for detecting HCV has been found, on which the following are attached:
a) at least one antibody directed against the HCV Core protein,
b) and at least one polypeptide comprising at least one epitope of the E2 protein of HCV and at least one epitope of a protein chosen from the E1, NS3, NS4 and NS5 proteins of HCV,
   and on which said at least one polypeptide does not comprise an epitope of the HCV Core protein.

In particular, the following are attached on the solid support for an immunological test for detecting HCV:
a) at least one antibody directed against the HCV Core protein,
b) at least one polypeptide comprising at least one epitope of the E2 protein of HCV,
c) and at least one polypeptide comprising at least one epitope of a protein chosen from the E1, NS3, NS4 and NS5 proteins of HCV,
   and on said support said at least one polypeptide does not comprise an epitope of the HCV Core protein.

The invention also proposes a method for detecting in vitro, an HCV infection in a biological sample, which comprises detecting at least one HCV antigen and an antibody directed against HCV present in the biological sample, and in which:

a support as described above is provided,

said support is incubated with the biological sample under conditions which allow the formation of antigen-antibody complexes,

the antigen-antibody complexes formed are revealed.

Advantageously, the solid support according to the invention comprises or consists of a) at least one antibody directed against the HCV Core protein, b) at least one polypeptide comprising or consisting of at least one epitope of the E2 protein of HCV and c) at least one polypeptide comprising or consisting of at least one epitope of a protein chosen from the NS3, NS4 and NS5 proteins of HCV, preferably NS4B and NS5A.

More advantageously, the solid support according to the invention comprises or consists of a) at least one antibody directed against the HCV Core protein, b) at least one polypeptide comprising or consisting of at least one epitope of the E2 protein of HCV and c) at least one polypeptide comprising or consisting of at least one epitope of NS3 of HCV and at least one epitope of a protein chosen from the NS4 and NS5 proteins of HCV.

Preferentially, the solid support according to the invention comprises or consists of a) at least one antibody directed against the HCV Core protein, b) at least one polypeptide comprising or consisting of at least one epitope of the E2 protein of HCV and c) at least one polypeptide comprising or consisting of at least one epitope of NS3 of HCV and at least one epitope of a protein chosen from the NS4B and NS5A proteins of HCV.

In another embodiment of the invention, the solid support according to the invention comprises or consists of a) at least one antibody directed against the HCV Core protein, b) at least one polypeptide comprising or consisting of at least one epitope of the E2 protein of HCV and c) at least one polypeptide comprising or consisting of at least one epitope of an NS4B protein of HCV and at least one epitope of an NS5A protein of HCV.

In any event, no polypeptide comprising an epitope of the HCV Core protein is attached to the solid support.

The term “HCV” (hepatitis C virus) covers all the strains, types, subtypes and genotypes of the virus responsible for hepatitis C. This includes the 6 main genotypes 1, 2, 3, 4, 5 and 6 and also their subtypes 1a, 1b, etc.

The regions of the HCV are defined approximately by the numbering used in Choo Q L et al. 1991 and are summarized in the table below for HCV 1:

| Domain | aa amino acid position |
|---|---|
| Core | 1-191 |
| E1 | 192-383 |
| E2 | 384-746 |
| P7 | 747-809 |
| NS2 | 810-1026 |
| NS3 | 1027-1657 |
| NS4A | 1658-1711 |
| NS4B | 1712-1972 |
| NS5A | 1973-2420 |
| NS5B | 2421-3011 |

The term “polypeptide” (or “antigen”) refers to a polymer of amino acids and is not limited to a minimum number of amino acids or to a particular size. The amino acids may be natural (the 20 encoding a protein) or synthetic, such as ornithine or γ-aminobutyric acid, or modified by glycosylation, acetylation, phosphorylation or the like, in such a way that the polypeptide retains the desired activity, in particular antigenic activity, with respect to antibodies produced by a patient against HCV.

The term “epitope” refers to a sequence of at least 3, 4 or 5 amino acids, in particular between 6-8 and 12-15 amino acids, which binds to an antibody. There is no critical upper size for an epitope. The sequence of an epitope may comprise “conservative” modifications which do not significantly change the binding between the epitope and the antibody from a specificity point of view.

The expression “at least one epitope of the X protein” is intended to mean the X protein or one or more of its epitopes. Thus, for example, the expression “at least one epitope of the E2 protein” is intended to mean the E2 protein itself or one or more of its epitopes.

Thus, according to one preferred embodiment of the invention, the following are attached on the solid support for an immunological test for detecting HCV:
a) at least one antibody directed against the HCV Core protein, and
b) a polypeptide consisting of (i) a peptide of the E2 protein of HCV, chosen from the E2 protein itself and one or more of its epitopes, and (ii) a peptide of the E1, NS4B and/or NS5A proteins of HCV, chosen from the proteins themselves or one or more of their epitopes, and, where appropriate, also (iii) a peptide of the NS3 protein, chosen from the protein itself and one or more of its epitopes.

Preferably, the peptide (ii) is chosen from the NS4B and NS5A proteins and one or more of their epitopes. More preferably, the peptide (iii) is not present in the polypeptide b).

According to another embodiment of the invention, the following are attached on the solid support for an immunological test for detecting HCV:
a) at least one antibody directed against the HCV Core protein,
b) a peptide of the E2 protein of HCV, chosen from the E2 protein itself or one or more of its epitopes, and
c) a peptide of the E1, NS4B and/or NS5A proteins of HCV, chosen from the proteins themselves and one or more of their epitopes, with, where appropriate,
d) a peptide of the NS3 protein, chosen from the protein itself and one or more of its epitopes.

Preferably, the peptide c) is chosen from the NS4B and NS5A proteins and one or more of their epitopes. More preferably, the support does not comprise any peptide d).

A polypeptide attached on the solid support may comprise several epitopes of different proteins, or even of different subtypes. Constructions of this type (Multiple Epitope Fusion Antigens: MEFA) are well described in WO 01/096875 or WO 97/44469.

Preferably, the polypeptide comprising at least one epitope of the E2 protein will be different than the polypeptide comprising at least one epitope of E1 and/or NS4 and/or NS5.

The term “E2 protein” is intended to mean an envelope glycoprotein having a molecular weight of approximately 70-72 kd. The term “E2 protein” also includes the mutants and truncated proteins which have an immunological behavior similar to the E2 protein (same cross reactivity between the two with a reference antibody). For example, one form of E2 described in the prior art extends from position 384 to 746, but another form of E2 extends up to position 809 and an E2 protein truncated beyond to position 683 is described in this application. Insertions have been described between amino acids 383 and 384, as have deletions between positions 384-387 (Kato et al 1992). Preferably, at least 10, 30, 50, 60, 63, 70, 80, 90 or 126 amino acids of the C-terminal part of the E2 protein are truncated therefrom.

The term “antibody” refers to any whole antibody or functional fragment of an antibody comprising or consisting of at least one antigenic combination site, allowing said antibody to bind to at least one epitope of an antigenic compound. By way of example of antibody fragments, mention may be made of Fab, Fab′ and F(ab′)₂ fragments and also scFv (single chain variable fragment) and dsFv (double-stranded variable fragment) chains. These functional fragments can in particular be obtained by genetic engineering.

The expression “at least one antibody directed against the Core protein” is intended to mean one or more anti-Core protein antibodies.

The antibodies according to the invention are either polyclonal antibodies or monoclonal antibodies.

The abovementioned polyclonal antibodies can be obtained by immunization of an animal with at least one antigen of interest, followed by recovering of the desired antibodies in purified form, by taking a sample of the serum of said animal, and separation of said antibodies from the other constituents of the serum, in particular by affinity chromatography on a column on which an antigen specifically recognized by the antibodies, in particular an antigen of interest, is attached.

The monoclonal antibodies can be obtained by the hybridoma technique, the general principle of which is summarized hereinafter: in a first step, an animal (generally a mouse or cells in culture in the case of in vitro immunizations), is immunized with an antigen of interest, the B lymphocytes thereof then being capable of producing antibodies against said antigen. These antibody-producing lymphocytes are subsequently fused with “immortal” myeloma cells so as to produce hybridomas. Using the heterogeneous mixture of cells thus obtained, a selection of cells capable of producing a particular antibody and of multiplying indefinitely is then carried out. Each hybridoma is multiplied in the form of a clone, each resulting in the production of a monoclonal antibody of which the properties of recognition with respect to the antigen of interest may be tested, for example, by ELISA, by one-dimensional or two-dimensional Western blotting, by immunofluorescence, or by means of a biosensor. The to monoclonal antibodies thus selected are subsequently purified, in particular according to the affinity chromatography technique.

In the context of the invention, a biological sample is preferably made up of a biological fluid, such as serum, plasma, blood or total blood, but also urine, tissue, cerebrospinal fluid, or the like. The biological sample can be treated in a prior step or brought into contact with the solid phase under the conditions, for example acidic conditions, which promote exposure of the antigens to be detected. Detergents of ionic or nonionic type, for example triton X100 or SDS (sodium dodecyl sulfate) and poly(oxyethylene) derivatives such as NP40 can be used.

The polypeptides of the invention are produced by techniques known per se by those skilled in the art, using the standard molecular biology and genetic engineering techniques, or chemically in the case of a peptide of smaller size, for example by solid-phase synthesis. All these techniques are well known to those skilled in the art. The epitope regions of an antigen can be determined by “epitope mapping” techniques as described in Methods in Molecular Biology, Epitope Mapping Protocols, vol 66, GE. Morris ed., 1996, Humana Press.

The term “labeling” is intended to mean the attachment of a label capable of directly or indirectly generating a detectable signal. A nonlimiting list of these labels consists of: enzymes which produce a signal detectable, for example, by colorimetry, fluorescence or luminescence, for instance horseradish peroxidase, alkaline phosphatase, α-galactosidase or glucose-6-phosphate dehydrogenase; chromophores, for instance fluorescent, luminescent or coloring compounds, radioactive molecules, for instance ³²P, ³⁵S or ¹²⁵I, and fluorescent molecules such as rhodamine or phycocyanins. Indirect systems can also be used, such as, for example, ligands capable or reacting with an anti-ligand. The ligand/anti-ligand pairings are well known to those skilled in the art, this being the case, for example, of the following pairings: biotin/streptavidin, hapten/antibody, antigen/antibody, peptide/antibody, sugar/lectin, polynucleotide/polynucleotide complementary thereto. In this case, it is the ligand which is attached to the polypeptide or the antibody. The anti-ligand may be detectable directly by means of the labels described in the preceding paragraph or itself be detectable by means of a ligand/anti-ligand.

The term “solid support” as used herein includes all the materials on which an antigen and/or an antibody can be immobilized for use in diagnostic tests. Natural or synthetic materials, which may or may not be chemically modified, can be used as a solid support, in particular polymers such as polyvinyl chloride, polyethylene, polystyrenes, polyacrylate or polyamide, or copolymers based on vinyl aromatic monomers, esters of unsaturated carboxylic acids, vinylidene chloride, dienes or compounds having nitrile functions (acrylonitrile); polymers of vinyl chloride and of propylene, polymers of vinyl chloride and vinyl acetate; copolymers based on styrenes or substituted derivatives of styrene; synthetic fibers, such as nylon; inorganic materials such as silica, glass, ceramic or quartz; latexes, magnetic particles; metal derivatives. The solid support according to the invention may be, without limitation, in the form of a microtitration plate, a sheet, a cone, a tube, a well, beads, particles or the like, or a flat support such as a silica or silicon wafer.

The attachment of the antigen(s) and antibody or antibodies on the solid support can be carried out by any direct or indirect means, in particular by passive adsorption. The attachment of the antigens and antibodies can be carried out as a mixture or sequentially, or a combination of the two.

In one particular embodiment, all the antigens and antibodies of the invention will be attached on the same zone, for example in a well of a microtitration plate.

In another embodiment, the antigens and the antibodies will be attached in discrete and therefore different zones of the solid support, such as, for example on a VIDAS cone (bioMérieux, Marcy l'Etoile), for example as used in the HIV DUO kit.

The presence of the antibodies and antigens in the biological sample is revealed by detection means. As regards the detection of the antigen, the invention provides in particular for detection using at least one detection antibody. Such a detection antibody, which is labeled, is capable of binding to the captured antigen, by affinity binding, by recognizing an epitope site, that is different than that recognized by the capture antibody, or identical owing to the presence of a repeat motif in the antigen.

As regards the detection of the antibodies, use may in particular be made of anti-immunoglobulin or anti-isotype antibodies, which are labeled, for example anti-immunoglobulin G antibodies or antigens which are labeled. All these detection techniques are well known to those skilled in the art.

The solid support according to the invention comprises at least one antibody directed against the Core protein, preferably at least two antibodies directed against the Core protein. In one preferential embodiment, at least one of these antibodies recognizes an epitope chosen from amino acid positions 2 to 120 of said core protein, particularly 15 to 90, advantageously the epitopes 20-24 (SEQ ID No. 10: QDVKF); 29-33 (SEQ ID No. 11: QIVGG); 58-65 (SEQ ID No. 12: PRGRRQPI); 29-37 (SEQ ID No. 13: QIVGGVYL); 7-17 (SEQ ID No. 14: RKTKRNTN); 34-39 (SEQ ID No. 15: VYLLPR); 73-86 (SEQ ID No. 16: GRTWAQPGYPWPLY) as defined in C. Jolivet-Reynaud et al (1998). Not having any problem of competition with the solid support according to the invention by virtue of the absence of the Core antigen on said support makes it possible to multiply the number of anti-Core antibodies attached to the solid support in order to improve the sensitivity or the specificity. It is therefore possible to have at least 2 or at least 3 antibodies attached to the solid support.

In one particular combination according to the invention, at least one polypeptide which comprises at least 10, advantageously 12, preferably 15 contiguous amino acids of the sequence SEQ ID No. 2 and/or the sequence SEQ ID No. 4 and/or the sequence SEQ ID No. 5 and/or the sequence SEQ ID No. 7 and/or SEQ ID No. 9 is attached to the solid support for the antibody detection part.

According to one particular embodiment, the support of the invention satisfies at least one of the following characteristics:
the peptide (ii) comprises at least 10 contiguous amino acids of the sequence SEQ ID No. 5 and/or SEQ ID No. 7, and
the peptide (i) comprises at least 10 contiguous amino acids of the sequence SEQ ID No. 2.

In another particular combination according to the invention, at least 3 different polypeptides comprising at least 10, advantageously 12, preferably 15 contiguous amino acids of the sequence SEQ ID No. 2 for a first polypeptide, of the sequence SEQ ID No. 4 for a second polypeptide and of the sequence SEQ ID No. 5 and/or SEQ ID No. 7 for the third, are attached on the solid support.

According to one particular embodiment, the support of the invention satisfies at least one of the following characteristics:
the peptide c) comprises at least 10 contiguous amino acids of the sequence SEQ ID No. 5 and/or SEQ ID No. 7, and
the peptide b) comprises at least 10 contiguous amino acids of the sequence SEQ ID No. 2.

This combined immunoassay can be carried out according to various formats well known to those skilled in the art: in solid phase or in homogeneous phase; in one step or in two steps; in a double sandwich method (sandwich for the two antigen and antibody detections); or in an indirect method (for the antibody detection) combined with a sandwich method (for the antigen detection), by way of nonlimiting examples.

An immunoassay format of sandwich between two antibodies (capture and detection) type is particularly advantageous for detecting the antigens present in the biological sample, whereas the antibodies can be revealed by using a capture antigen and a labeled conjugate which binds to the antibody (according to a format commonly denoted indirect format).

An immunoassay format for antigen detection by competition is also possible. Other immunoassay modes can also be envisioned and are well known to those skilled in the art.

The simultaneous detection of an HCV antigen and of an antibody directed against the HCV microorganism can be carried out in a single step, namely by simultaneously bringing together the biological sample and the detection means, such as in particular the detection antibody or antibodies, at the same time as the capture antibody or antibodies and the capture antigen(s). In this case, the antigen detection immunoassay and the antibody detection immunoassay are both carried out preferably in sandwich format. Alternatively, the detection means, such as in particular the detection antibody or antibodies, can be added to the mixture in a second step, i.e. after the first antigen/antibody complexes have formed. This is then referred to as a two-step assay.

The invention will be understood more clearly from the following examples given by way of nonlimiting illustration, and also from the appended FIGS. 1 and 2 in which:

### FIGURES

FIG. 1 represents an example of an ELISA assay using a solid support according to the invention on which an anti-Core protein antibody and also 4 HCV antigens, respectively E2, NS3, NS4 and NS5, are attached. A biological sample from patient A is incubated in contact with this solid support. This sample, which may be serum, potentially contains anti-HCV, in particular anti-E2 and/or NS3 and/or NS4 and/or NS5, antibodies and antigens of the virus, in particular Core antigens, capable of reacting with the biological reagents present on the solid support. The binding of these antibodies and antigens from the sample is revealed with a monoclonal anti-Core antibody linked to alkaline phosphatase (AP) and a monoclonal anti-human IgG antibody (in the figure, an Fab′ fragment) which is itself also labeled with alkaline phosphatase.

FIG. 2 represents the sequence composition of the PTalpha-E2-24 clone: the EF1 alpha promoter is followed by the EcoRI restriction site and the region containing the sequence of the immunoglobulin G variable region heavy chain (VH leader, sequence underlined) interrupted with an intron sequence (sequence in italics). The cloning of the gene encoding the E2 protein (H384 to Q673) containing the tags (Maximilian: MRGSHHH and His₆: HHHHHH) was carried out after ligation of the PCR fragment digested with Bsu361 and XbaI.

### EXAMPLE 1

### Material Used

The protein sequences are indicated according to the nomenclature of the one-letter code for amino acids, from N-terminal to C-terminal.

### 1.1 Anti-Core Protein Monoclonal Antibodies

The monoclonal antibodies were obtained after immunization of 4- to 6-week-old female BALB/c JYco mice (IFFA Credo, Les Oncins, L'Arbresle, France). The mice were immunized intraperitoneally. The protocol consisted of seven injections of the purified HCV Core protein (10 micrograms/ml) carried out at two-week intervals. The protein injections are carried out with complete Freund's adjuvant for the first and incomplete Freund's adjuvant for the subsequent injections. Four days after the final injection, the spleen cells were selected and fused, according to the protocol proposed by Köhler and Milstein (1975, 1976), with Sp2/0-Ag14 mouse myeloid cells. After 12 to 14 days, the cell culture supernatants were evaluated using an immunoenzymatic assay (ELISA), in which the same antigen used for the immunizations was deposited in the solid phase. The positive clones secreting anti-Core protein antibodies were subcloned twice by the limiting dilution method. The ascites were obtained from the mice after intraperitoneal injection of 0.5 ml of pristane and 10⁶ hybridoma cells. The anti-Core protein IgG monoclonal antibodies were purified on a protein-A sepharose to 4FF column according to the instructions of Pharmacia. The purified monoclonal antibodies were biotinylated with the Sulfo-NHS-LC-Biotin reagent (Merck, Rockford, Ill.) according to Gretch et al (1987) for the antigenic determination tests.

Once the antibodies were available, it was possible to carry out the identification of the epitopes recognized on the HCV Core protein. The results of the identification of the specific epitopes by 9 anti-Core protein monoclonal antibodies obtained were published by Jolivet-Reynaud et al (1998). Several antibodies were selected by this process, and in particular 19D9D6, 7G9B8 and 7G12A8. The 19D9D6 monoclonal antibody belongs to group I and recognizes the first 45 amino acids of the HCV Core protein, more precisely the region comprising amino acids 25 to 45. According to the crystal structure of the immunodominant antigenic site of the HCV Core protein complexed with the 19D9D6 monoclonal antibody, it appears that the minimum linear epitope recognized is QIVGGVYLL located between amino acids 29-37 (Ménez et al (2003)).

### 1.2 E2 Protein

In order to carry out the ELISA assays, it was necessary to produce and purify the E2 envelope protein.

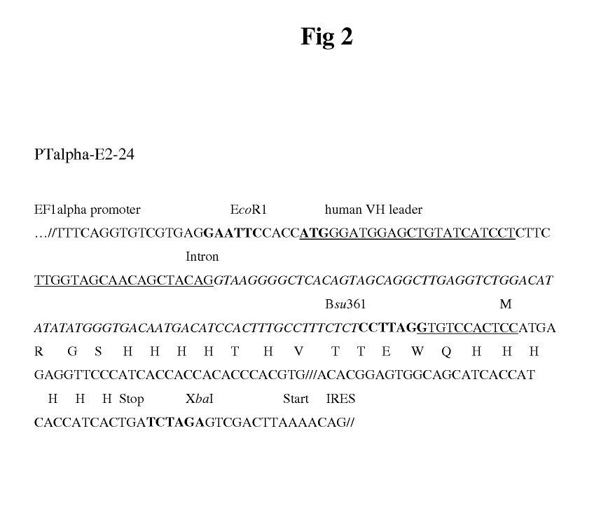

The DNA fragment encoding the ectodomain of envelope 2 (aa 384-673 of the HCV genome according to Choo et al 1991) was amplified from the HCV-JA strain (genotype 1b, plasmid pCMV-C980) by PCR and cloned into the stable expression vector pT-alpha. The envelope gene is under the control of the human EF1 promoter and of the human poliovirus IRES (“Internal Ribosome Entry Site”) in which the mouse DHFR (dihydrofolate reductase) gene (selectable marker) is contained. Two additional “tag” signature sequences were introduced during the cloning, the first called Maximilian tag (MRGSHHH amino acid (aa) sequence represented by the one-letter code) located in 5′ of the N-terminal gene of the protein translated and the second, His₆-tag (HHHHHH), located in 3′. The HCV E2 construct was checked by sequencing and its expression was verified by immunoblotting (anti-Maximilian tag and anti-His₆-tag antibodies) after transfection. The transfection of CHO (Chinese Hamster Ovary) DHFR-cells was carried out by electroporation of the pT-alpha E2 plasmid. Nucleoside-free medium was used to select the positive clones. The clones were amplified in order to increase the number of copies of the gene encoding envelope 2 integrated into the plasmid using an increasing concentration of methotrexate (MTX): 20 nM, 100 nM, 250 nM, 500 nM, 1 micromol, 2 micromol, 4 micromol and 8 micromol. The cell line expressing the E2 protein was subcloned and the clone, called PTalpha-E2-24, was selected. The composition of this clone is described in FIG. 2. Other COS-type eukaryotic expression systems can be used to express this E2 protein.

Once the E2 clone had been amplified, a purification protocol was developed by means of the histidine tags. The histidine tags make it possible to purify the HCV E2 protein with a metal-chelate resin, such as, for example, Ni-NTA from the company Qiagen, directly from the culture supernatant. The amounts of HCV E2 recovered after elution indicate that the maximum theoretical binding capacity of the column is reached. It should be noted that no signal is detected in the washing buffer after it has passed over the column. Alternatively, the electrophoresis gels were stained with the Blue-PAGE reagent (Fermentas) in order to evaluate the degree of purity of the purified protein. In the purified and concentrated final sample, only the HCV E2 protein is detected after staining. The degree of purity is therefore estimated at 95%. Finally, the samples obtained were assayed with the micro-BCA kit (Pierce). The production and purification method makes it possible to reproducibly obtain 5 mg of protein per liter of supernatant.

When the PTalpha-E2-24 clone is expressed in the CHO system, the E2 sequence expressed is the following SEQ ID No. 1:

MRGSHHHTHVTGGRVASSTQSLVSWLSQGPSQKIQLVNTNGSWHINRTAL
NCNDSLQTGFIAALFYAHRFNASGCPERMASCRPIDKFAQGWGPITHVVP
NISDQRPYCWHYAPQPCGIVPASQVCGPVYCFTPSPVVVGTTDRSGVPTY
SWGENETDVLLLNNTRPPQGNWFGCTWMNSTGFTKTCGGPPCNIGGVGNN
TLICPTDCFRKHPEATYTKCGSGPWLTPRCLVDYPYRLWHYPCTINFTIF
KVRMYVGGVEHRLNAACNWTRGERCDLEDRDRSELSPLLLSTTEWQHHHH
HH.

The part in bold represents the amino acids introduced into the sequence by the plasmid.

The sequence without these amino acids from the plasmid is indicated by SEQ ID No. 2.

### 1.3 NS3 Protein

The gene encoding the NS3 helicase domain protein (amino acids: 1192-1458 according to Choo Q L et al (1991)), genotype 1b, was cloned into the pMR80 expression vector (Cheynet et al, 1993) as a fusion with 6 histidines located in the 5′ position of the NS3 helicase domain gene, as previously described (Arribillaga et al., 2002). Briefly, the Escherichia coli bacterial strain JM109 was inoculated into 50 ml of LB medium (Bacto-Tryptone 10 g/l; yeast extract 5 g/l, NaCl 10 g/l) supplemented with 100 microg/ml of ampicillin, and cultured overnight at 37° C. The following day, the culture of the recombinant bacterial strain was diluted to 1/50 and cultured at 37° C. until the optical density (OD₆₀₀) reached 0.6. The expression of the NS3 helicase domain protein was induced after the addition of 1 mM isopropyl-beta-D-thiogalactopyranoside (IPTG) (Gibco/BRL), for 3 to 4 hours at 30° C. with agitation at 250 rpm (units of revolution). After this time, the bacterial pellet was taken up in lysis buffer and subjected to sonication, and then centrifuged at 25 000 g for 30 min. The soluble fraction was used for the purification on an Ni-NTA agarose column (Qiagen) according to the manufacturer's instructions. The recombinant NS3 helicase domain protein was purified with 300 mM of imidazole and dialyzed overnight into PBS. The protein was analyzed in a Coomassie blue gel after 12% SDS gel electrophoresis and by mass spectrometry by MALDI-TOF analysis with the Voyager DE-PRO instrument.

The amino acid sequence of the NS3 genotype 1b protein expressed is SEQ ID No. 3:

MRGSHHHHHHGSVDESMDEFAVDFIPVESMETTMRSPVFTDNSSPPAVPQ
TFQVAHLHAPTGSGKSTKVPAAYAAQGYKVRVLNPSVAATLGFGAYMSKA
HGIEPNIRTGVRTITTGGPITYSTYGKFLADGGCSGGAYDIIICDECHST
DWTTILGIGTVLDQAETAGARLVVLATATPPGSITVPHPNIEEVALSNTG
EIPFYGKAIPIEAIKGGRHLIFCHSKKKCDELAAKLTGLGLNAVAYYRGL
DVSVIPTSGDVVVVATDALMTGFTGDFDSVIDCNTCV.

The part in bold represents the amino acids introduced into the sequence by the plasmid. The sequence of NS3 without these amino acids from the plasmid is indicated by SEQ ID No. 4.

In the same way, an NS3 helicase domain protein, but corresponding to genotype 1a, is prepared according to the same procedure.

The amino acid sequence of the NS3 genotype 1a protein expressed is SEQ ID No. 8:

MRGSHHHHHHGSVDESMDEFAVDFIPVENLETTMRSPVFSDNSSPPAVPQ
SYQVAHLHAPTGSGKSTKVPAAYAAQGYKVLVLNPSVAATLGFGAYMSKA
HGIDPNIRTGVRTITTGSPITYSTYGKFLADGGCSGGAYDIIICDECHST
DATSILGIGTVLDQAETAGARLTVLATATPPGSVTVPHPNIEEVALSTTG
EIPFYGKAIPLEAIKGGRHLIFCHSKKKCNELAAKLVALGVNAVAYYRGL
DVSVIPTSGDVVVVATDALMTGFTGDFDSVIDCNTCV.

The part in bold represents the amino acids introduced into the sequence by the plasmid. The sequence of NS3 genotype 1a without the amino acids introduced by the plasmid is indicated by SEQ ID No. 9.

### 1.4 NS4B Protein

The synthetic peptide prepared according to the usual solid-phase methods and derived from NS4B genotype 1b comprises the 31 amino acids from positions 1909 to 1939 relative to the numbering of the HCV-1 strain (Choo et al (1991)). The sequence is SEQ ID No. 5: GEGAVQWMNRLIAFASRGNHVSPTHYVPESD.

### 1.5 NS5A Protein

The gene encoding the NS5A protein (amino acids: 2212 to 2311 according to Choo Q. L. et al (1991)), genotype 1b, was cloned into a pET21b plasmid and expressed in E. coli BL21 as a fusion with 6 histidines located in the 3′ position of the NS5 gene. Briefly, the Escherichia coli bacterial strain JM109 was inoculated into 50 ml of LB medium (bacto-tryptone 10 g/l; yeast extract 5 g/l, NaCl 10 g/l) supplemented with 100 micrograms/ml of ampicillin, and cultured overnight at 37° C. The following day, the culture of the recombinant bacterial strain was diluted to 1/50 and cultured at 37° C. until the optical density (OD₆₀₀) reached 0.6. The expression of the NS5 protein was induced after the addition of 0.4 mM isopropyl-beta-D-thiogalactopyranoside (IPTG) (Gibco/BRL), for 3 to 4 hours at 30° C. with agitation at 250 rpm. After this time, the bacterial pellet was taken up in lysis buffer and subjected to sonication, and then centrifuged at 25 000 g for 30 min. The stable fraction was used for the purification on an Ni-NTA agarose column (Qiagen) according to the instructions proposed by the manufacturer. The recombinant NS5 protein was purified with 300 mM of imidazole and dialyzed overnight into PBS. The protein was analyzed by electrophoresis on a 12% SDS gel stained with Coomassie blue and by MALDI-TOF mass spectrometry (voyager DE-PRO).

The amino acid sequence of the NS5A protein expressed is SEQ ID No. 6:

MASKATCTTHHDSPDADLIEANLLWRQEMGGNITRVESENKVVILDSFDP
LRAEEDEREVSVAAEILRKSKKFPPALPIWARPDYNPPLLESWKSPDYVP
PAVMRGSHHHHHH.

The part in bold represents the amino acids introduced into the sequence by the plasmid.

The sequence of NS5A without these amino acids introduced by the plasmid is indicated by SEQ ID No. 7.

### EXAMPLE 2

### Test Format

The assay can be carried out in 96-well plates, with the antigens either separate in individual wells, or as a mixture in a single well.
2.1 Format of the Assay with the Antigens Separate

1. Coating of the Wells

a. Anti-Core Protein Antibody

The wells are coated for 2 hours at 37° C. on a 96-well MaxiSorb microplate (Nunc), with 200 microliters of a solution of the anti-Core protein mouse monoclonal antibody 19D9D6 diluted to 4 micrograms/ml in TBS buffer (Tris buffered with a saline solution). The plates are washed 3 times with 300 microliters of TBS-0.05% Tween 20 (washing buffer) and then passivated overnight at ambient temperature in a TBS-0.05% Tween 20 buffer containing 20 g/l BSA (Sigma), and 0.1 g/1 mouse IgG (Scantibodies laboratory) (passivation buffer). The plates are washed 3 times with 300 microliters of washing buffer.

b. E2 Protein

The wells are coated for 2 hours at 37° C. on 96-well MaxiSorb microplates (Nunc), with 200 microliters of a solution of the antigen diluted to 1 microgram/ml in TBS buffer. The plates are washed 3 times with 300 microliters of TBS-0.05% Tween 20 (washing buffer) and then passivated overnight at ambient temperature in a TBS-0.05% Tween 20 buffer containing 20 g/l BSA (Sigma) and 0.1 g/1 mouse IgG (Scantibodies laboratory). The plates are washed 3 times with 300 microliters of washing buffer.

c. NS3, NS4B and NS5A

The protocol for each protein is identical to that described above for the E2 protein.

2. Incubation of the Sample

The wells are incubated with 200 microliters of sample diluted to 1/10 in passivation buffer, for 1 hour at 37° C., and then washed 5 times with 300 microliters of washing buffer.

3. Incubation of the Conjugates

a. Conjugate for Detecting the Core Protein.

200 microliters of a solution of the anti-Core protein mouse monoclonal antibody 19D9D6 conjugated to alkaline phosphatase, diluted to 0.1 microgram/ml in passivation buffer, are incubated for 1 hour at 37° C. The wells are washed 5 times with 300 microliters of washing buffer.

b. Conjugate for Detecting the Serum Antibodies

The wells coated with the E2, NS3, NS4B or NS5A antigens are incubated for 1 hour at 37° C. with 200 microliters of a solution of anti-human IgG Fab′ conjugated with alkaline phosphatase, diluted to 0.05 microgram/ml in passivation buffer. The wells are washed 5 times with 300 microliters of washing buffer.

4. Developing

The reaction is developed with 200 microliters of a pNPP substrate (Sigma) for 30 min at ambient temperature and stopped by adding 50 microliters of 1M NaOH. The signal is read on a microplate reader at 405 nm. The cut-off value is calculated from the signal given by the mean of 3 negative samples+3 times the standard deviation of this signal. The result can be expressed as signal/cut-off (s/co) ratio; an s/co of greater than 1 is interpreted as positive.

2.2 Results of the Assay with the Antigens Separate:

The precocity of the detection using the test format with the antigens separate is evaluated with 10 panels of seroconversion of HCV patients supplied by Zeptometrix Corp (panel HCV 9044, 6212, 6213, 6214, 6215 and 6227) and Seracare BBI diagnostics (panels PHV908, PHV910(M), PHV911 and PHV917(M)). The samples are plasmas resulting from longitudinal samples taken from individuals infected with HCV. The results are expressed as signal/cut-off; values greater than 1 are considered to be positive.

The PHV911, 9044, 6212, 6213 and 6215 panels are tested with the NS3 genotype 1a protein and the PHV908, PHV910(M), PHV917(M), 6214 and 6227 panels with the NS3 genotype 1b protein.

The first column represents a serum of the panel with its ID identification number.

Each antigen (E2, NS3, NS4B, NS5A) is measured individually and is represented in the subsequent columns. The final column represents the results for detection of antigens with the 19D9D6 antibody.

TABLE 1

| ID | E2 | NS3 | NS4B | NS5A | 19D9D6 |
|---|---|---|---|---|---|
| PHV908-1 | 0.5 | 0.7 | 0.6 | 0.3 | 0.1 |
| PHV908-2 | 0.7 | 0.9 | 0.6 | 0.4 | 0.0 |
| PHV908-3 | 0.5 | 0.7 | 0.8 | 0.5 | 0.2 |
| PHV908-4 | 0.5 | 0.4 | 0.4 | 0.5 | 0.2 |
| PHV908-5 | 0.8 | 0.5 | 0.4 | 0.3 | 0.3 |
| PHV908-6 | 1.2 | 0.4 | 0.3 | 0.2 | 0.0 |
| PHV908-7 | 1.7 | 0.4 | 0.2 | 0.0 | 0.1 |
| PHV908-8 | 2.2 | 0.5 | 0.3 | 0.2 | 0.1 |
| PHV908-9 | 2.0 | 0.6 | 0.3 | 0.3 | 0.1 |
| PHV908-10 | 2.2 | 0.9 | 0.5 | 0.3 | 0.2 |
| PHV908-11 | 1.7 | 1.0 | 0.5 | 0.3 | 0.0 |
| PHV908-12 | 1.3 | 0.8 | 0.4 | 0.7 | 0.2 |
| PHV908-13 | 1.3 | 1.0 | 0.5 | 0.3 | 0.1 |

TABLE 2

| ID | E2 | NS3 | NS4B | NS5A | 19D9D6 |
|---|---|---|---|---|---|
| PHV 910(M)-2 | 1.6 | 0.8 | 0.9 | 0.4 | 0.0 |
| PHV 910(M)-3 | 11.8 | 0.8 | 0.8 | 0.3 | 0.1 |
| PHV 910(M)-4 | 18.0 | 0.7 | 2.7 | 0.3 | 0.3 |
| PHV 910(M)-5 | 22.6 | 1.0 | 17.3 | 0.7 | 0.1 |

TABLE 3

| ID | E2 | NS3 | NS4B | NS5A | 19D9D6 |
|---|---|---|---|---|---|
| PHV911-2 | 0.2 | 0.5 | 0.7 | 0.2 | 0.1 |
| PHV911-3 | 0.2 | 0.6 | 0.7 | 0.3 | 0.3 |
| PHV911-4 | 0.8 | 9.5 | 2.0 | 0.5 | 0.1 |
| PHV911-5 | 1.7 | 17.1 | 3.7 | 0.4 | 0.1 |

TABLE 4

| ID | E2 | NS3 | NS4B | NS5A | 19D9D6 |
|---|---|---|---|---|---|
| PHV917(M)-1 | 1.0 | 1.0 | 0.7 | 0.7 | 0.2 |
| PHV917(M)-3 | 0.9 | 0.9 | 0.8 | 0.7 | 0.1 |
| PHV917(M)-4 | 0.6 | 0.6 | 1.3 | 1.3 | 0.2 |
| PHV917(M)-5 | 4.8 | 1.5 | 1.1 | 2.3 | 0.2 |
| PHV917(M)-6 | 1.9 | 3.7 | 0.9 | 1.4 | 0.0 |
| PHV917(M)-7 | 1.6 | 6.7 | 0.7 | 1.1 | 0.2 |
| PHV917(M)-8 | 1.5 | 7.0 | 0.7 | 1.1 | 0.7 |
| PHV917(M)-9 | 1.7 | 29.5 | 1.5 | 1.4 | 3.0 |
| PHV917(M)-10 | 1.6 | 32.8 | 0.8 | 1.1 | 1.2 |

TABLE 5

| ID | E2 | NS3 | NS4B | NS5A | 19D9D6 |
|---|---|---|---|---|---|
| 9044-1 | 0.4 | 2.4 | 0.6 | 0.4 | 0.5 |
| 9044-2 | 0.3 | 2.1 | 0.5 | 0.3 | 0.3 |
| 9044-3 | 0.3 | 2.0 | 0.5 | 0.3 | 0.3 |
| 9044-4 | 0.4 | 2.8 | 0.5 | 0.4 | 0.3 |
| 9044-5 | 0.8 | 6.7 | 0.5 | 2.0 | 0.4 |
| 9044-6 | 1.2 | 9.5 | 0.6 | 7.2 | 0.3 |

TABLE 6

| ID | E2 | NS3 | NS4B | NS5A | 19D9D6 |
|---|---|---|---|---|---|
| 6212-1 | 0.6 | 0.4 | 0.9 | 0.5 | 0.4 |
| 6212-2 | 0.8 | 0.4 | 1.0 | 0.5 | 0.1 |
| 6212-3 | 0.9 | 0.4 | 1.0 | 0.7 | 0.1 |
| 6212-4 | 0.5 | 0.5 | 0.4 | 0.3 | 0.2 |
| 6212-5 | 0.3 | 0.7 | 0.7 | 0.5 | 0.0 |
| 6212-6 | 0.3 | 1.4 | 0.8 | 0.5 | 0.2 |
| 6212-7 | 0.1 | 2.7 | 0.7 | 0.6 | 0.4 |
| 6212-8 | 0.3 | 15.0 | 0.9 | 0.6 | 0.3 |
| 6212-9 | 0.7 | 15.0 | 0.9 | 0.6 | 0.3 |

TABLE 7

| ID | E2 | NS3 | NS4B | NS5A | 19D9D6 |
|---|---|---|---|---|---|
| 6213-1 | 0.3 | 0.5 | 0.7 | 0.3 | 0.4 |
| 6213-2 | 0.3 | 0.5 | 0.5 | 0.4 | 0.3 |
| 6213-3 | 0.4 | 0.7 | 0.5 | 0.3 | 0.5 |
| 6213-4 | 0.3 | 0.6 | 0.5 | 0.4 | 0.3 |
| 6213-5 | 0.3 | 0.5 | 0.6 | 0.3 | 0.2 |
| 6213-6 | 0.3 | 0.5 | 0.4 | 0.3 | 0.7 |
| 6213-7 | 0.3 | 0.5 | 0.4 | 0.3 | 0.4 |
| 6213-8 | 0.2 | 0.3 | 0.4 | 0.2 | 0.6 |
| 6213-9 | 0.3 | 0.6 | 0.7 | 0.3 | 0.3 |
| 6213-10 | 0.4 | 1.0 | 0.6 | 0.5 | 0.3 |
| 6213-11 | 0.4 | 9.7 | 0.7 | 0.5 | 0.4 |
| 6213-12 | 0.4 | 10.6 | 0.7 | 0.4 | 0.3 |

TABLE 8

| ID | E2 | NS3 | NS4B | NS5A | 19D9D6 |
|---|---|---|---|---|---|
| 6214-1 | 1.0 | 0.9 | 1.1 | 0.8 | 0.5 |
| 6214-2 | 1.3 | 1.2 | 1.4 | 0.6 | 0.6 |
| 6214-3 | 0.8 | 0.7 | 0.9 | 0.5 | 0.3 |
| 6214-4 | 0.5 | 0.5 | 0.9 | 0.6 | 0.5 |
| 6214-5 | 0.5 | 0.4 | 0.8 | 0.6 | 0.3 |
| 6214-6 | 0.1 | 0.3 | 0.8 | 0.7 | 0.4 |
| 6214-7 | 0.3 | 0.4 | 0.9 | 0.8 | 0.5 |
| 6214-8 | 0.7 | 0.6 | 1.2 | 0.7 | 0.7 |
| 6214-9 | 1.3 | 1.0 | 1.3 | 0.9 | 0.4 |
| 6214-10 | 1.7 | 1.0 | 1.2 | 0.7 | 0.6 |
| 6214-11 | 1.5 | 1.3 | 0.9 | 0.6 | 0.3 |
| 6214-12 | 1.5 | 1.1 | 1.0 | 0.6 | 0.6 |
| 6214-13 | 1.5 | 1.2 | 1.1 | 0.7 | 0.3 |

TABLE 9

| ID | E2 | NS3 | NS4B | NS5A | 19D9D6 |
|---|---|---|---|---|---|
| 6215-1 | 0.6 | 3.3 | 0.6 | 0.1 | 0.3 |
| 6215-2 | 0.6 | 3.0 | 0.4 | 0.1 | 0.3 |
| 6215-3 | 1.6 | 3.2 | 0.8 | 0.2 | 0.2 |
| 6215-4 | 0.7 | 3.1 | 0.5 | 0.1 | 0.2 |

TABLE 10

| ID | E2 | NS3 | NS4B | NS5A | 19D9D6 |
|---|---|---|---|---|---|
| 6227-1 | 0.7 | 0.6 | 1.0 | 0.8 | 0.8 |
| 6227-2 | 0.4 | 0.4 | 0.9 | 0.7 | 0.7 |
| 6227-3 | 0.9 | 0.7 | 1.1 | 0.8 | 0.9 |
| 6227-4 | 1.2 | 0.9 | 1.2 | 0.9 | 0.8 |
| 6227-5 | 1.2 | 1.0 | 1.1 | 0.8 | 0.6 |
| 6227-6 | 10.6 | 1.3 | 1.4 | 0.8 | 0.5 |
| 6227-7 | 11.6 | 0.9 | 1.2 | 0.7 | 0.6 |

These tests on the seroconversion panels show that the E2 antigen brings about an earlier detection. Nevertheless, the early effect of detection of NS4 appears in tables 2, 3 4 and 8, that of NS3 appears in tables 5, 6, 7 and 9 and that of NS5 in tables 4 and 5.

### EXAMPLE 3

### Assay with the E2, NS31a, NS31b, NS4 and NS5 Antigens as a Mixture

### 3.1 Assay Format

1. Coating of the Wells:

The wells are coated overnight at ambient temperature on 96-well MaxiSorb microplates (Nunc), with 100 microliters of a following solution of antigens as a mixture, diluted in PBS buffer: E2: 1 microgram/ml, NS3 genotype 1a: 0.5 microgram/ml, NS3 genotype 1b: 0.5 microgram/ml, NS4B: 1 microgram/ml, NS5A: 1 microgram/ml. The plates are washed 3 times with 300 microliters of TBS-0.05% Tween 20 (washing buffer) and then passivated for 2 hours at 37° C. in TBS-0.05% Tween 20 buffer containing 20 g/l BSA (Sigma) and 2.5 g/l casein. The plates are washed 3 times with 300 microliters of washing buffer.

2. Incubation of the Sample

The wells are incubated with 100 microliters of sample, diluted to 1/100 in passivation buffer, for 1 hour at 37° C. and then washed 3 times with 300 microliters of washing buffer.

3. Incubation of the Conjugates

The wells are incubated for 1 hour at 37° C. with 100 microliters of a solution of anti-human IgG conjugated with a horseradish peroxidase (HRP) enzyme (Jackson Immunoresearch) diluted to 0.1 microgram/ml and anti-human IgM (bioMérieux) diluted to 0.025 microgram/ml in passivation buffer. The wells are washed 3 times with 300 microliters of washing buffer.

4. Developing

The reaction is developed with 100 microliters of an O-phenylenediamine substrate (Calbiochem) for 30 min at ambient temperature and stopped by adding 50 μl of 0.5M H₂SO₄. The signal is read on a microplate reader at 492 nm. The cut-off value is calculated from the signal given by the mean of 3 negative samples to which is added 3 times the standard deviation of this signal. The result can be expressed as signal/cut-off (s/co) ratio; an s/co of greater than 1 is interpreted as positive.

### 3.2 Results Regarding the Seroconversion Panels

The precocity of the detection using the test format with the antigens as a mixture is evaluated with 11 seroconversion panels supplied by Zeptometrix Corp (panel HCV 9044, 6212, 6213, 6214, 6215 and 6227) and Seracare/BBI diagnostics (panels PHV907, PHV908, PHV910(M), PHV911 and PHV917(M)). The samples are plasmas resulting from longitudinal samples taken from individuals infected with HCV. The results are expressed as signal/cut-off; values greater than 1 are considered to be positive. The first column indicates the identification code for the sample. The second column indicates the number of days since taking the initial sample for the same patient (longitudinal samples). The third column indicates the result expressed as signal/cut-off obtained with a commercial kit Ortho EIA 3.0, which is a commercial kit for early detection of seroconversion for HCV which uses a Core peptide (C22-3) and an NS3-NS4 polypeptide (C200). The fourth column indicates the result expressed as signal/cut-off with the antigens as a mixture. Each table corresponds to a series of samples taken for the same patient.

TABLE 11

| | | | E2 + NS3 + |
|---|---|---|---|
| | | Ortho EIA | NS4B + NS5A |
| ID | Days | s/co | s/co |
| PHV907-1 | 0 | 0 | 0.4 |
| PHV907-2 | 4 | 0 | 0.3 |
| PHV907-3 | 7 | 0 | 0.4 |
| PHV907-4 | 13 | 0.1 | 0.4 |
| PHV907-5 | 18 | 0.4 | 0.6 |
| PHV907-6 | 21 | 1 | 1.3 |
| PHV907-7 | 164 | 4.4 | 6.1 |

TABLE 12

| | | | E2 + NS3 + |
|---|---|---|---|
| | | Ortho EIA | NS4B + NS5A |
| ID | Days | s/co | s/co |
| PHV908-01 | 0 | 0 | 0.3 |
| PHV908-02 | 3 | 0 | 0.5 |
| PHV908-03 | 5 | 0 | 0.5 |
| PHV908-04 | 11 | 0.1 | 0.8 |
| PHV908-05 | 13 | 0.3 | 0.9 |
| PHV908-06 | 19 | 1.7 | 1.3 |
| PHV908-07 | 25 | 4.9 | 1.8 |
| PHV908-08 | 27 | 4.9 | 1.7 |
| PHV908-09 | 32 | >5 | 2.0 |
| PHV908-10 | 35 | >5 | 2.5 |
| PHV908-11 | 41 | >5 | 2.4 |
| PHV908-12 | 45 | >5 | 2.9 |
| PHV908-13 | 48 | >5 | 2.6 |

TABLE 13

| | | | E2 + NS3 + |
|---|---|---|---|
| | | Ortho EIA | NS4B + NS5A |
| ID | Days | s/co | s/co |
| 910-2 | 4 | 0 | 1.0 |
| 910-3 | 8 | 2.1 | 1.4 |
| 910-4 | 11 | >5 | 2.2 |
| 910-5 | 15 | >5 | 5.6 |

TABLE 14

| | | | E2 + NS3 + |
|---|---|---|---|
| | | Ortho EIA | NS4B + NS5A |
| ID | Days | s/co | s/co |
| PHV911-02 | 3 | 0.0 | 0.5 |
| PHV911-03 | 14 | 1.6 | 0.4 |
| PHV911-04 | 21 | >5.0 | 3.3 |
| PHV911-05 | 24 | >5.0 | 5.2 |

TABLE 15

| | | | E2 + NS3 + |
|---|---|---|---|
| | | Ortho EIA | NS4B + NS5A |
| ID | Days | s/co | s/co |
| 917-1 | 0 | 0 | 0.5 |
| 917-3 | 20 | 0 | 0.6 |
| 917-4 | 22 | 0 | 0.5 |
| 917-5 | 85 | >4.7 | 1.1 |
| 917-6 | 131 | >4.8 | 1.7 |
| 917-7 | 135 | >4.9 | 2.0 |
| 917-8 | 138 | >4.10 | 2.4 |
| 917-9 | 146 | >4.11 | 4.9 |
| 917-10 | 152 | >4.12 | 5.5 |

TABLE 16

| | | | E2 + NS3 + |
|---|---|---|---|
| | | Ortho EIA | NS4B + NS5A |
| ID | Days | s/co | s/co |
| 9044-1 | 0 | 0.005 | 1.2 |
| 9044-2 | 4 | 0.003 | 0.6 |
| 9044-3 | 17 | 0.003 | 0.6 |
| 9044-4 | 21 | 0.124 | 0.8 |
| 9044-5 | 25 | 1.364 | 1.8 |
| 9044-6 | 29 | 1.864 | 3.3 |

TABLE 17

| | | | E2 + NS3 + |
|---|---|---|---|
| | | Ortho EIA | NS4B + NS5A |
| ID | Days | s/co | s/co |
| 6212-1 | 0 | 0.003 | 0.2 |
| 6212-2 | 12 | 0.149 | 0.3 |
| 6212-3 | 14 | 0.297 | 0.2 |
| 6212-4 | 23 | 1.489 | 0.3 |
| 6212-5 | 26 | 1.866 | 0.4 |
| 6212-6 | 32 | 2.369 | 0.8 |
| 6212-7 | 37 | 2.461 | 1.0 |
| 6212-8 | 51 | 4.132 | 5.7 |

TABLE 18

| | | | E2 + NS3 + |
|---|---|---|---|
| | | Ortho EIA | NS4B + NS5A |
| ID | Days | s/co | s/co |
| 6213-1 | 0 | 0.015 | 0.4 |
| 6213-2 | 2 | 0.012 | 0.2 |
| 6213-3 | 8 | 0.01 | 0.3 |
| 6213-4 | 11 | 0.009 | 0.3 |
| 6213-5 | 15 | 0.061 | 0.3 |
| 6213-6 | 17 | 0.009 | 0.2 |
| 6213-7 | 27 | 0.007 | 0.2 |
| 6213-8 | 29 | 0.009 | 0.7 |
| 6213-9 | 34 | 0.02 | 1.4 |
| 6213-10 | 36 | 0.51 | 1.4 |
| 6213-11 | 42 | 4.126 | 2.9 |
| 6213-12 | 46 | 4.126 | 3.3 |

TABLE 19

| | | | E2 + NS3 + |
|---|---|---|---|
| | | Ortho EIA | NS4B + NS5A |
| ID | Days | s/co | s/co |
| 6215-1 | 0 | 0.01 | 0.4 |
| 6215-2 | 3 | 0.01 | 0.6 |
| 6215-3 | 10 | 0.01 | 0.8 |
| 6215-4 | 19 | 3.05 | 0.4 |

TABLE 20

| | | Ortho EIA | E2 + NS3 + NS4B + NS5A |
|---|---|---|---|
| ID | Days | s/co | s/co |
| 6227-1 | 0 | 0.029 | 0.2 |
| 6227-2 | 21 | 0.067 | 0.2 |
| 6227-3 | 23 | 0.028 | 0.3 |
| 6227-4 | 41 | 0.042 | 0.2 |
| 6227-5 | 44 | 0.028 | 0.1 |
| 6227-6 | 74 | 3.686 | 0.9 |
| 6227-7 | 76 | 3.73 | 1.2 |

These comparative tables between an FDA-approved and CE-marked commercial kit, containing at least one epitope of the Core protein, and a research prototype show that the combination of antigens chosen in the invention gives very satisfactory and much earlier results. An inter-patient variability is always observed. For example, the mixture of antigens according to example 3 allows an early detection at 8 days in the case of table 18, but not as early in tables 17, 19 or 20. It is therefore necessary to add the antigen detection in order to increase the sensitivity.

### EXAMPLE 4

### Detection of the Antibodies Directed Against the Epitopes of the Anti-E2, NS3, NS4B and NS5A Proteins Compared with the Detection of the Core Antigen

### 4.1 Assay Format

1. Anti-E2, NS3, NS4B and NS5A Antibody Detection Format

The protocol is identical to that described in example 3.1 with the same mixture of antigens attached at the bottom of the plate.

2. Core Antigen Detection Format

The protocol is identical to that described in example 2.1, paragraph 1a.

### 4.2 Results on 100 Randomly Selected HCV-Positive Sera

The performance levels of the assay were evaluated on 100 samples of sera taken from individuals infected with HCV.

Out of the 100 sera tested, 2 sera, 57544 and 57302, show a positive result by detection of the Core antigen and not by detection of the antibodies. These 2 sera therefore justify the principle of a combo test since these 2 sera, without the detection of the antigen, would have given a negative result.

TABLE 21

| | E2 + NS3 + NS4B + NS5A | Core Ag |
|---|---|---|
| Serum ID | s/co | s/co |
| 57744 | 0.5 | 3.0 |
| 57302 | 0.4 | 3.0 |

### EXAMPLE 5

### Assay Format in Combined Antigen and Antibody Mode with the E2, NS4B and NS5A Antigens as a Mixture with the 19D9D6 Antibody

### 5.1 Assay Format:

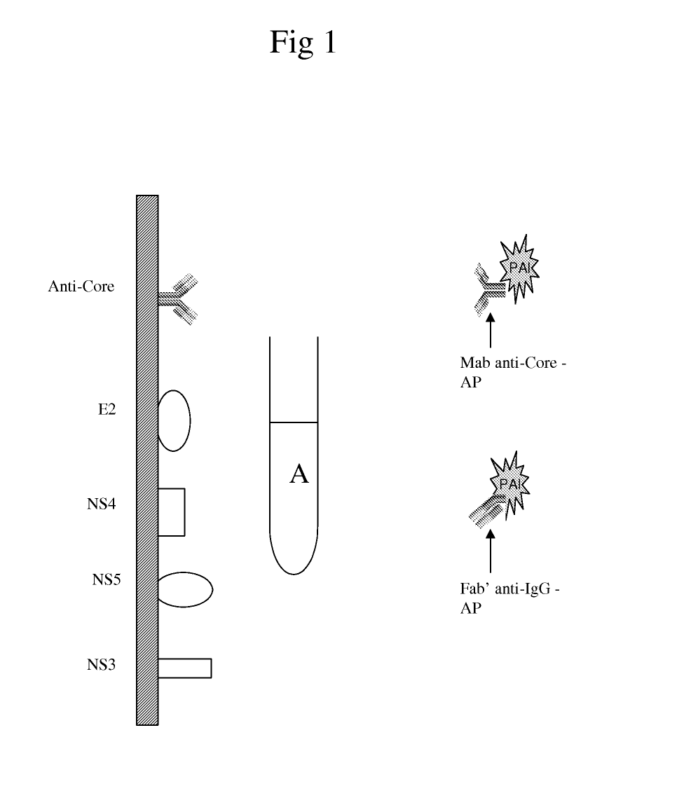

The scheme of the test is described in FIG. 1.

1. Coating of the Wells:

The wells are coated for 2 hours at 37° C. with 100 microliters of a solution of antigens (E2, NS4B and NS5A) each diluted to 1 microgram/ml in TBS buffer (tris buffered with a saline solution), and then washed with 3×300 microliters of TBS; and the anti-Core protein antibody 19D9D6 is in addition attached to said wells by passive adsorption for 2 hours at 37° C. with 200 microliters of a solution of said antibody diluted to 4 micrograms/ml in TBS buffer. The plates are washed with 3 times 300 microliters of TBS-0.05% Tween 20 (washing buffer), and then passivated overnight at ambient temperature in a TBS-0.05% Tween 20 buffer containing 20 g/l BSA (Sigma) and 0.1 g/1 mouse IgG (Scantibodies laboratory) (passivation buffer). The plates are washed with 3 times 300 microliters of washing buffer.

2. Incubation of the Sample

The wells are incubated with 200 microliters of sample diluted to 1/10 in passivation buffer, for 1 hour at 37° C., and then washed 5 times with 300 microliters of washing buffer.

3. Incubation of the Conjugates

The wells are incubated for 1 hour at 37° C. with 200 microliters of a solution of the anti-core antibody 19D9D6 conjugated with alkaline phosphatase, diluted to 0.1 microgram/ml, and an anti-human IgG Fab′ conjugated with alkaline phosphatase, diluted to 0.05 microgram/ml in passivation buffer. The wells are washed 5 times with 300 microliters of washing buffer.

4. Developing

The reaction is developed as for the previous examples.

### 5.2 Results

The precocity of the detection using the test format with the antigens as a mixture described in example 2 is evaluated with 2 seroconversion panels supplied by Zeptometrix Corp (panel HCV6214) and Seracare BBI diagnostics (panel PHV910(M)). The samples are plasmas resulting from longitudinal samples taken from individuals infected with HCV. The results are expressed in signal/cut-off; values above 1 are considered to be positive. The precocity of the detection is compared with other methods: nucleic acid assay (Roche Amplicor PCR test or Bayer bDNA 3.0 test) and Ortho EIA 3.0.

TABLE 22
Seroconversion panel PHV910(M):

| | | Roche | | |
|---|---|---|---|---|
| | | Amplicor | Ortho EIA 3 | Assay 5 |
| ID | Days | PCR | s/co | s/co |
| 910-2 | 4 | >5E+5 | 0 | 1.8 |
| 910-3 | 8 | >5E+5 | 2.1 | 2.5 |
| 910-4 | 11 | >5E+5 | >5 | 3.6 |
| 910-5 | 15 | >5E+5 | >5 | 5.0 |

The data show that the combo test detects the infection 4 days earlier than the commercial Ortho EIA 3 test. The nucleic acid assay indicates the presence of the virus from the first sample onward.

TABLE 23
Seroconversion panel 6214:

| | | BAYER bDNA | Ortho EIA 3 | Assay 5 |
|---|---|---|---|---|
| ID | Days | Number of copies/ml | s/co | s/co |
| 6214-1 | 0 | 6 357 000 | 0.003 | 0.4 |
| 6214-2 | 2 | 6 998 000 | 0.002 | 0.3 |
| 6214-3 | 8 | 8 946 000 | 0.001 | 0.3 |
| 6214-4 | 10 | 6 910 000 | 0.003 | 0.3 |
| 6214-5 | 16 | 5 574 000 | 0.005 | 0.3 |
| 6214-6 | 18 | 3 312 000 | 0.003 | 0.3 |
| 6214-7 | 23 | 5 374 000 | 0.005 | 2.2 |
| 6214-8 | 27 | 11 200 000 | 0.012 | 3.5 |
| 6214-9 | 32 | 9 265 000 | 0.900 | 4.1 |
| 6214-10 | 34 | 6 278 000 | 2.643 | 3.9 |
| 6214-11 | 49 | 2 446 000 | 4.126 | 3.9 |
| 6214-12 | 53 | 2 939 000 | 4.126 | 4.0 |
| 6214-13 | 56 | 2 031 000 | 4.126 | 4.5 |

The data show that the combo test of example 5 detects the infection 11 days earlier to than the commercial Ortho EIA 3 test. The nucleic acid assay (reference method) indicates the presence of the virus from the first sample onward.

### EXAMPLE 6

### Assay Format in Combined Antigen and Antibody Mode with the E2, NS3, NS4B and NS5A Antigens as a Mixture with the 7G9B8 and 7G12A8 Antibodies

### 6.1 Assay Format:

The scheme of the test is described in FIG. 1.

1. Coating of the Wells

The wells are coated for 2 hours at 37° C. with 100 microliters of a solution of antigens, each diluted to 1 microgram/ml in PBS buffer; and then washed with 3 times 300 microliters of PBS; and again coated for 2 hours at 37° C. with 200 microliters of a solution of the anti-Core antibodies 7G9B8 and 7G12A8, each diluted to 0.5 microgram/ml in PBS buffer. The plates are washed with 3 times 300 microliters of PBS-0.05% Tween 20 (washing buffer) and then passivated overnight at ambient temperature in a PBS-0.05% Tween 20 buffer containing 1% casein (passivation buffer). The plates are washed with 3 times 300 microliters of washing buffer.

2. Incubation of the Sample

The wells are incubated with 200 microliters of sample diluted to 1/3 in TBS-0.05% Tween buffer containing 10% goat serum, for 1 hour at 37° C., and then washed 3 times with 300 microliters of washing buffer.

3. Incubation of the Conjugates

The wells are incubated for 1 hour at 37° C. with 200 microliters of a solution of anti-core antibodies 19D9D6 conjugated with horseradish peroxidase (HRP), diluted to 1 microgram/ml, conjugated (HRP) anti-human IgG diluted to 0.1 microgram/ml, and conjugated (HRP) anti-human IgM diluted to 0.1 microgram/ml in passivation buffer. The wells are washed 3 times with 300 microliters of washing buffer.

4. Developing

The reaction is developed with 100 microliters of an O-phenylenediamine substrate (Calbiochem) for 30 min at ambient temperature and stopped by adding 50 microliters of 0.5M H₂SO₄. The signal is read on a microplate reader at 492 nm

### 6.2 Results Regarding the Seroconversion Panels

The precocity of the detection is evaluated with 11 seroconversion panels supplied by Zeptometrix Corp (panel HCV9044, 6212, 6213, 6214, 6215 and 6227) and Seracare BBI diagnostics (panels PHV907, PHV908, PHV910(M), PHV911 and PHV917(M)). The samples are plasmas resulting from longitudinal samples taken from individuals infected with HCV. The cut-off value is calculated from the signal given by the mean of 3 negative samples plus 3 times the standard deviation of this signal. The result can be expressed as signal/cut-off (s/co) ratio; and s/co greater than 1 is interpreted as positive.

TABLE 24

| | | Ortho EIA | |
|---|---|---|---|
| ID | Days | s/co | Assay 6 |
| PHV907-1 | 0 | 0 | 1.4 |
| PHV907-2 | 4 | 0 | 1.3 |
| PHV907-3 | 7 | 0 | 1.2 |
| PHV907-4 | 13 | 0.1 | 1.4 |
| PHV907-5 | 18 | 0.4 | 1.4 |
| PHV907-6 | 21 | 1 | 1.6 |
| PHV907-7 | 164 | 4.4 | 1.9 |

TABLE 25

| | | Ortho EIA | |
|---|---|---|---|
| ID | Days | s/co | Assay 6 |
| PHV908-01 | 0 | 0 | 1.1 |
| PHV908-02 | 3 | 0 | 0.9 |
| PHV908-03 | 5 | 0 | 1.1 |
| PHV908-04 | 11 | 0.1 | 1.1 |
| PHV908-05 | 13 | 0.3 | 1.4 |
| PHV908-06 | 19 | 1.7 | 1.5 |
| PHV908-07 | 25 | 4.9 | 1.6 |
| PHV908-08 | 27 | 4.9 | 1.7 |
| PHV908-09 | 32 | >5 | 1.3 |
| PHV908-10 | 35 | >5 | 1.5 |
| PHV908-11 | 41 | >5 | 1.4 |
| PHV908-12 | 45 | >5 | 1.6 |

TABLE 26

| | | Ortho EIA | |
|---|---|---|---|
| ID | Days | s/co | Assay 6 |
| 910-2 | 4 | 0 | 1.5 |
| 910-3 | 8 | 2.1 | 1.6 |
| 910-4 | 11 | >5 | 1.9 |
| 910-5 | 15 | >5 | 1.8 |

TABLE 27

| | | Ortho EIA | |
|---|---|---|---|
| ID | Days | s/co | Assay 6 |
| PHV911-02 | 3 | 0.0 | 0.8 |
| PHV911-03 | 14 | 1.6 | 1.0 |
| PHV911-04 | 21 | >5.0 | 1.7 |
| PHV911-05 | 24 | >5.0 | 1.7 |

TABLE 28

| | | Ortho EIA | |
|---|---|---|---|
| ID | Days | s/co | Assay 6 |
| 917-1 | 0 | 0 | 1.4 |
| 917-3 | 20 | 0 | 1.0 |
| 917-4 | 22 | 0 | 1.2 |
| 917-5 | 85 | >4.7 | 1.2 |
| 917-6 | 131 | >4.8 | 1.4 |
| 917-7 | 135 | >4.9 | 1.4 |
| 917-8 | 138 | >4.10 | 1.5 |
| 917-9 | 146 | >4.11 | 1.7 |

TABLE 29

| | | Ortho EIA | |
|---|---|---|---|
| ID | Days | s/co | Assay 6 |
| 9044-1 | 0 | 0.005 | 1.1 |
| 9044-2 | 4 | 0.003 | 1.1 |
| 9044-3 | 17 | 0.003 | 1.3 |
| 9044-4 | 21 | 0.124 | 1.1 |
| 9044-5 | 25 | 1.364 | 1.3 |
| 9044-6 | 29 | 1.864 | 1.4 |

TABLE 30

| | | Ortho EIA | |
|---|---|---|---|
| ID | Days | s/co | Assay 6 |
| 6212-1 | 0 | 0.003 | 0.8 |
| 6212-2 | 12 | 0.149 | 1.0 |
| 6212-3 | 14 | 0.297 | 0.8 |
| 6212-4 | 23 | 1.489 | 1.1 |
| 6212-5 | 26 | 1.866 | 1.0 |
| 6212-6 | 32 | 2.369 | 1.1 |
| 6212-7 | 37 | 2.461 | 1.3 |
| 6212-8 | 51 | 4.132 | 1.6 |
| 6212-9 | 53 | 4.132 | 1.4 |

TABLE 31

| | | Ortho EIA | |
|---|---|---|---|
| ID | Days | s/co | Assay 6 |
| 6213-1 | 0 | 0.015 | 1.3 |
| 6213-2 | 2 | 0.012 | 1.3 |
| 6213-3 | 8 | 0.01 | 1.5 |
| 6213-4 | 11 | 0.009 | 1.3 |
| 6213-5 | 15 | 0.061 | 1.1 |
| 6213-6 | 17 | 0.009 | 1.4 |
| 6213-7 | 27 | 0.007 | 1.2 |
| 6213-8 | 29 | 0.009 | 1.3 |
| 6213-9 | 34 | 0.02 | 1.3 |
| 6213-10 | 36 | 0.51 | 1.2 |
| 6213-11 | 42 | 4.126 | 1.7 |
| 6213-12 | 46 | 4.126 | 1.5 |

TABLE 32

| | | Ortho EIA | |
|---|---|---|---|
| ID | Days | s/co | Assay 6 |
| 6214-1 | 0 | 0.003 | 1.1 |
| 6214-2 | 2 | 0.002 | 1.2 |
| 6214-3 | 8 | 0 | 1.0 |
| 6214-4 | 10 | 0.003 | 1.2 |
| 6214-5 | 16 | 0.005 | 1.0 |
| 6214-6 | 18 | 0.003 | 1.0 |
| 6214-7 | 23 | 0.005 | 1.1 |
| 6214-8 | 27 | 0.012 | 1.1 |
| 6214-9 | 32 | 0.9 | 1.3 |
| 6214-10 | 34 | 2.643 | 1.2 |
| 6214-11 | 49 | 4.126 | 1.7 |
| 6214-12 | 53 | 4.126 | 1.8 |

TABLE 33

| | | Ortho EIA | |
|---|---|---|---|
| ID | Days | s/co | Assay 6 |
| 6215-1 | 0 | 0.01 | 0.7 |
| 6215-2 | 3 | 0.01 | 0.7 |
| 6215-3 | 10 | 0.01 | 1.2 |
| 6215-4 | 19 | 3.05 | 0.9 |

TABLE 34

| | | Ortho EIA | |
|---|---|---|---|
| ID | Days | s/co | Assay 6 |
| 6227-1 | 0 | 0.029 | 0.7 |
| 6227-2 | 21 | 0.067 | 0.6 |
| 6227-3 | 23 | 0.028 | 0.6 |
| 6227-4 | 41 | 0.042 | 1.1 |
| 6227-5 | 44 | 0.028 | 1.0 |
| 6227-6 | 74 | 3.686 | 1.3 |
| 6227-7 | 76 | 3.73 | 1.5 |

The combination used in assay 6 gives better results than the Ortho test for most of the panels, and detects with at least the same sensitivity for tables 27 and 30.

### LITERATURE

Alter M. J. et al, N. Engl. J. Med., 1992, 327, 1899-1905.
Arribillaga L. et al, Vaccine, 2002, 21, 202-210.
Cheynet V. et al, Prot. Expr. Purif., 1993, 4(5), 367-472.
Choo Q. L. et al, Science, 1989, 244, 359-362.
Choo Q. L. et al, Proc. Nat. Acad. Sci. USA, 1991, 88, 2451-2455.
Courouce A M et al, Lancet, 1994, 343, 853-854.
Garson J A et al, Lancet. 1990, 336, 1022-1025.
Gretch D. R. et al, Anal. Biochem, 1987, 163, 270-277.
Han J. H. et al, Proc. Nat. Acad. Sci. USA, 1991, 88(5), 1711-1715.
Jolivet-Reynaud C. et al, Journal of Medical Virology, 1998, 56, 300-309.
Kato N. et al, Virus Res., 1992, 22, 107-123.
Köhler G. and Milstein C., Nature, 1975, 256, 45-47.
Köhler G. and Milstein C., Eur. J. Immunology, 1976, 6, 511-519.
Ménez A. et al, J. Immunology, 2003, 170, 1917-1924.
Mimms L. et al, Lancet, 1990, 336, 1590-1591.
Takahashi K. et al, J. Gen. Virol., 1992, 73, 667-672.

1. A solid support for an immunological test for detecting HCV, on which the following are attached:
a) at least one antibody directed against the HCV Core protein, and
b) a polypeptide consisting of (i) a peptide of the E2 protein of HCV, chosen from the E2 protein itself and one or more of its epitopes, and (ii) a peptide of the E1, NS4B and/or NS5A proteins of HCV, chosen from the proteins themselves and one or more of their epitopes, and, where appropriate, (iii) a peptide of the NS3 protein, chosen from the protein it-self and one or more of its epitopes.

2. The solid support for an immunological test for detecting HCV as claimed in claim 1, characterized in that the peptide (ii) is chosen from the NS4B and NS5A proteins and one or more of their epitopes.

3. The solid support for an immunological test for detecting HCV as claimed in claim 2, characterized in that the peptide (ii) comprises at least 10 contiguous amino acids of the sequence SEQ ID No. 5 and/or SEQ ID No. 7.

4. The solid support for an immunological test for detecting HCV as claimed in claims 1 to 3, characterized in that the peptide (i) comprises at least 10 contiguous amino acids of the sequence SEQ ID No. 2.

5. The solid support for an immunological test for detecting HCV as claimed in claims 1 to 4, characterized in that the polypeptide b) does not comprise any peptide (iii).

6. A solid support for an immunological test for detecting HCV, on which the following are attached:
a) at least one antibody directed against the HCV Core protein,
b) a peptide of the E2 protein of HCV, chosen from the E2 protein itself or one or more of its epitopes, and
c) a peptide of the E1, NS4B and/or NS5A proteins of HCV, chosen from the proteins themselves and one or more of their epitopes, with, where appropriate,
d) a peptide of the NS3 protein, chosen from the protein itself and one or more its epitopes.

7. The solid support for an immunological test for detecting HCV as claimed in claim 6, characterized in that the peptide c) is chosen from the NS4B and NS5A proteins and one or more of their epitopes.

8. The solid support for an immunological test for detecting HCV as claimed in claim 7, characterized in that the peptide c) comprises at least 10 contiguous amino acids of the sequence SEQ ID No. 5 and/or SEQ ID No. 7.

9. The solid support for an immunological test for detecting HCV as claimed in claims 6 to 8, characterized in that the peptide b) comprises at least 10 contiguous amino acids of the sequence SEQ ID No. 2.

10. The solid support for an immunological test for detecting HCV as claimed in claims 6 to 9, which does not comprise any peptide of the NS3 protein d).

11. A method for detecting, in vitro, an HCV infection in a biological sample, which comprises detecting at least one HCV antigen and an antibody directed against HCV present in the biological sample, and in which:
a support as claimed in any one of claims 1 to 10 is provided,
said support is incubated with the biological sample under conditions which allow the formation of antigen-antibody complexes,
the antigen-antibody complexes formed are revealed.


SEQUENCE LISTING (16 sequences)

SEQ ID NO: 1 - protein, 302 aa, Artificial sequence
  HCV cloned E2
MRGSHHHTHVTGGRVASSTQSLVSWLSQGPSQKIQLVNTNGSWHINRTALNCNDSLQTGFIAALFYAHRFNASGCPERMASCRPIDKFAQGWGPITHVVPNISDQRPYCWHYAPQPCGIVPASQVCGPVYCFTPSPVVVGTTDRSGVPTYSWGENETDVLLLNNTRPPQGNWFGCTWMNSTGFTKTCGGPPCNIGGVGNNTLICPTDCFRKHPEATYTKCGSGPWLTPRCLVDYPYRLWHYPCTINFTIFKVRMYVGGVEHRLNAACNWTRGERCDLEDRDRSELSPLLLSTTEWQHHHHHH

SEQ ID NO: 2 - protein, 288 aa, Hepatitis C virus
HVTGGRVASSTQSLVSWLSQGPSQKIQLVNTNGSWHINRTALNCNDSLQTGFIAALFYAHRFNASGCPERMASCRPIDKFAQGWGPITHVVPNISDQRPYCWHYAPQPCGIVPASQVCGPVYCFTPSPVVVGTTDRSGVPTYSWGENETDVLLLNNTRPPQGNWFGCTWMNSTGFTKTCGGPPCNIGGVGNNTLICPTDCFRKHPEATYTKCGSGPWLTPRCLVDYPYRLWHYPCTINFTIFKVRMYVGGVEHRLNAACNWTRGERCDLEDRDRSELSPLLLSTTEWQ

SEQ ID NO: 3 - protein, 287 aa, Artificial sequence
  HCV cloned NS3 1b
MRGSHHHHHHGSVDESMDEFAVDFIPVESMETTMRSPVFTDNSSPPAVPQTFQVAHLHAPTGSGKSTKVPAAYAAQGYKVRVLNPSVAATLGFGAYMSKAHGIEPNIRTGVRTITTGGPITYSTYGKFLADGGCSGGAYDIIICDECHSTDWTTILGIGTVLDQAETAGARLVVLATATPPGSITVPHPNIEEVALSNTGEIPFYGKAIPIEAIKGGRHLIFCHSKKKCDELAAKLTGLGLNAVAYYRGLDVSVIPTSGDVVVVATDALMTGFTGDFDSVIDCNTCV

SEQ ID NO: 4 - protein, 267 aa, Hepatitis C virus
AVDFIPVESMETTMRSPVFTDNSSPPAVPQTFQVAHLHAPTGSGKSTKVPAAYAAQGYKVRVLNPSVAATLGFGAYMSKAHGIEPNIRTGVRTITTGGPITYSTYGKFLADGGCSGGAYDIIICDECHSTDWTTILGIGTVLDQAETAGARLVVLATATPPGSITVPHPNIEEVALSNTGEIPFYGKAIPIEAIKGGRHLIFCHSKKKCDELAAKLTGLGLNAVAYYRGLDVSVIPTSGDVVVVATDALMTGFTGDFDSVIDCNTCV

SEQ ID NO: 5 - protein, 31 aa, Hepatitis C virus
GEGAVQWMNRLIAFASRGNHVSPTHYVPESD

SEQ ID NO: 6 - protein, 113 aa, artificial sequence
  HCV cloned NS5A
MASKATCTTHHDSPDADLIEANLLWRQEMGGNITRVESENKVVILDSFDPLRAEEDEREVSVAAEILRKSKKFPPALPIWARPDYNPPLLESWKSPDYVPPAVMRGSHHHHHH

SEQ ID NO: 7 - protein, 100 aa, Hepatitis C virus
KATCTTHHDSPDADLIEANLLWRQEMGGNITRVESENKVVILDSFDPLRAEEDEREVSVAAEILRKSKKFPPALPIWARPDYNPPLLESWKSPDYVPPAV

SEQ ID NO: 8 - protein, 287 aa, artificial sequence
  HCV cloned NS3 1a
MRGSHHHHHHGSVDESMDEFAVDFIPVENLETTMRSPVFSDNSSPPAVPQSYQVAHLHAPTGSGKSTKVPAAYAAQGYKVLVLNPSVAATLGFGAYMSKAHGIDPNIRTGVRTITTGSPITYSTYGKFLADGGCSGGAYDIIICDECHSTDATSILGIGTVLDQAETAGARLTVLATATPPGSVTVPHPNIEEVALSTTGEIPFYGKAIPLEAIKGGRHLIFCHSKKKCNELAAKLVALGVNAVAYYRGLDVSVIPTSGDVVVVATDALMTGFTGDFDSVIDCNTCV

SEQ ID NO: 9 - protein, 267 aa, Hepatitis C virus
AVDFIPVENLETTMRSPVFSDNSSPPAVPQSYQVAHLHAPTGSGKSTKVPAAYAAQGYKVLVLNPSVAATLGFGAYMSKAHGIDPNIRTGVRTITTGSPITYSTYGKFLADGGCSGGAYDIIICDECHSTDATSILGIGTVLDQAETAGARLTVLATATPPGSVTVPHPNIEEVALSTTGEIPFYGKAIPLEAIKGGRHLIFCHSKKKCNELAAKLVALGVNAVAYYRGLDVSVIPTSGDVVVVATDALMTGFTGDFDSVIDCNTCV

SEQ ID NO: 10 - protein, 5 aa, artificial sequence
  epitope
QDVKF

SEQ ID NO: 11 - protein, 5 aa, artificial sequence
  epitope
QIVGG

SEQ ID NO: 12 - protein, 8 aa, artificial sequence
  epitope
PRGRRQPI

SEQ ID NO: 13 - protein, 8 aa, artificial sequence
  epitope
QIVGGVYL

SEQ ID NO: 14 - protein, 8 aa, artificial sequence
  epitope
RKTKRNTN

SEQ ID NO: 15 - protein, 6 aa, artificial sequence
  epitope
VYLLPR

SEQ ID NO: 16 - protein, 14 aa, artificial sequence
  epitope
GRTWAQPGYPWPLY